(19) United States
(12) Patent Application Publication
(10) Pub. No.: US 2016/0227485 A1
(43) Pub. Date: Aug. 4, 2016

(54) DRS BASED POWER CONTROL IN COMMUNICATION SYSTEMS

(71) Applicant: Intel Corporation, Santa Clara, CA (US)

(72) Inventors: Alexei Davydov, Nizhny Novgorod (RU); Seunghee Han, San Jose, CA (US); Gregory V. Morozov, Nizhny Novgorod (RU)

(73) Assignee: Intel Corporation, Santa Clara, CA (US)

(21) Appl. No.: 14/863,665

(22) Filed: Sep. 24, 2015

Related U.S. Application Data
(60) Provisional application No. 62/109,451, filed on Jan. 29, 2015.

(51) Int. Cl. H04W 52/14; H04L 5/00

(52) U.S. Cl. CPC H04W 52/146; H04L 5/0048; H04W 52/242

(57) ABSTRACT

Apparatus, systems, and methods to implement DRS-based power control in communication systems are described. In one example, a network entity comprises processing circuitry to configure at least one discovery reference signal (DRS) for path loss measurement, determine a discovery reference signal power setting and transmit the discovery reference signal (DRS) via a wireless communication link. Other examples are also disclosed and claimed.

### RELATED APPLICATIONS

This application claims the benefit of priority under 35 U.S.C. §119(e) of U.S. Provisional Application Ser. No. 61/109,451, filed Jan. 29, 2015, entitled DRS-BASED OPEN-LOOP POWER CONTROL FOR LTE-A UPLINK, the disclosure of which is incorporated herein by reference in its entirety.

### FIELD

The present disclosure generally relates to the field of electronic communication. More particularly, aspects generally relate to DRS based power control in communication systems.

### BACKGROUND

Electronic devices which communicate via a wireless network need to manage the power level at which uplink (UL) signals are transmitted in order to reduce interference devices. Accordingly, techniques to manage transmission power levels may find utility, e.g., in electronic communication systems for electronic devices.

### BRIEF DESCRIPTION OF THE DRAWINGS

The detailed description is provided with reference to the accompanying figures. The use of the same reference numbers in different figures indicates similar or identical items.

FIG. 1 is a schematic, block diagram illustration of an exemplary communication system in accordance with various examples discussed herein.

FIG. 2 is a schematic, block diagram illustration of functional components of user equipment in accordance with various examples discussed herein.

FIG. 3 is a flowchart illustrating high-level operations in a method to implement DRS based power control in communication systems in accordance with various examples discussed herein.

FIG. 4 is a schematic, block diagram illustration of a wireless network in accordance with one or more exemplary embodiments disclosed herein.

FIG. 5 is a schematic, block diagram illustration of a 3GPP LTE network in accordance with one or more exemplary embodiments disclosed herein.

FIGS. 6 and 7 are schematic, block diagram illustrations, respectively, of radio interface protocol structures between a UE and an eNodeB based on a 3GPP-type radio access network standard in accordance with one or more exemplary embodiments disclosed herein.

FIG. 8 is a schematic, block diagram illustration of an information-handling system in accordance with one or more exemplary embodiments disclosed herein.

FIG. 9 is an isometric view of an exemplary embodiment of the information-handling system of FIG. 10 that optionally may include a touch screen in accordance with one or more embodiments disclosed herein.

FIG. 10 is a schematic, block diagram illustration of components of user equipment in accordance with one or more exemplary embodiments disclosed herein.

It will be appreciated that for simplicity and/or clarity of illustration, elements illustrated in the figures have not necessarily been drawn to scale. For example, the dimensions of some of the elements may be exaggerated relative to other elements for clarity. Further, if considered appropriate, reference numerals have been repeated among the figures to indicate corresponding and/or analogous elements.

### DETAILED DESCRIPTION

In the following description, numerous specific details are set forth in order to provide a thorough understanding of various examples. However, various examples may be practiced without the specific details. In other instances, well-known methods, procedures, components, and circuits have not been described in detail so as not to obscure the particular examples. Further, various aspects of examples may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

Reference throughout this specification to “one embodiment” or “an embodiment” means that a particular feature, structure or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures or characteristics may be combined in any suitable manner in one or more embodiments. Additionally, the word “exemplary” is used herein to mean “serving as an example, instance, or illustration.” Any embodiment described herein as “exemplary” is not to be construed as necessarily preferred or advantageous over other embodiments.

Various operations may be described as multiple discrete operations in turn and in a manner that is most helpful in understanding the claimed subject matter. The order of description, however, should not be construed as to imply that these operations are necessarily order dependent. In particular, these operations need not be performed in the order of presentation. Operations described may be performed in a different order than the described embodiment. Various additional operations may be performed and/or described operations may be omitted in additional embodiments.

As described above, electronic devices which communicate via a wireless network need to manage the power level at which uplink (UL) signals are transmitted in order to reduce interference devices. For example, user equipment which operates in full-dimension multiple-input multiple-output (FD MIMO) mode utilizes uplink transmission power management to reduce, or at least to manage, interference between user equipment (UE).

Discovery reference signals (DRS) may be used in cellular networks to support synchronization and radio resource management (RRM) measurement for small cells capable of operating in on/off mode. Small cell on/off mode may be used to support LTE-A with licensed assisted access. DRS signals are transmitted when the cell is in both ‘off’ and ‘on’ states. For DRS based discovery procedure UE can be configured with at least one discovery reference signal measurement timing configuration (DMTC) per frequency, indicating when UE may perform cell detection and RRM measurement based on DRS. DRS measurement timing configuration includes period and offset and potentially duration with respect to timing of the primary serving cell.

DRS are transmitted only on downlink (DL) subframes or in the downlink pilot time slot (DwPTS) region of DL subframes and in one DRS occasion consists of one instance of a primary synchronization signal and secondary synchronization signal (PSS/SSS), a cell-specific reference signal (CRS) transmitted at least in the same subframe(s) as PSS/SSS, channel state information reference signal (CSI-RS) configuration which may be in the same or different subframe(s) and scrambled independently w.r.t PSS/SSS and CRS transmissions. The relative subframe offset between PSS/SSS and one CSI-RS may be variable or fixed within 5 milliseconds (msec) relative to subframe with PSS/SSS. A DRS occasion for a cell comprises N consecutive subframes (N<=5), which is transmitted by each cell every M ms, where M are 40, 80, 160. DRS may be used for RRM measurement such as reference signal received power (RSRP) measurement.

In some examples a network entity operating in accordance with FD MIMO configures one or more DRS which contain reference signals with different pre-coding or beamforming. The DRS may be configured for RRM measurements. Based on RSRP measurements from DRS (e.g. RSRP measured on CSI-RS of DRS), a serving eNB may identify the best pre-coding and apply a similar pre-coding for physical downlink shared channel (PDSCH) transmission. For example, UE may be configured with multiple DRS, where each DRS is pre-coded with a vertically down tilted beam. UE may be also configured with DRS based RSRP measurement and reporting. Based on RSRP measurement results from UE, the serving eNB may determine the best vertical pre-coding or beamforming vector and apply a similar vector for PDSCH transmission.

Open loop power control (OLPC) is performed by the UE without dynamic signaling from the network. OLPC compensates for long-term channel variations such as path loss attenuation and shadowing fading. By contrast, closed loop power control (CLPC) is provides more tight control on UE transmit power using dynamic signaling. In accordance with eNB signaling the UE tries to adjust its transmit power such that the transmission power per Resource Block (RB) remains constant independently of the allocated transmission bandwidth. In other words, as long as there is no downlink control information (DCI) signaling from the eNB on the Physical Downlink Control Channel (PDCCH) or Enhanced Physical Downlink Control Channel (EPDCCH), the UE autonomously performs OLPC based on path loss (PL) estimation from the reference signals, broadcasted system parameters and dedicated signaling. When the UE receives a power control command in DCI, the UE adjust the transmission power in accordance with the command. The power control is supported for physical uplink shared channel (PUSCH), the physical uplink control channel (PUCCH) and sounding reference signal (SRS) uplink transmission. For PUSCH the transmit power (in dBm) is set by the UE according to the following equation:

P_{PUSCH}=min(Pₘₐₓ,10 log₁₀M+P₀+α·PL+Δ_{TF}+Δᵢ) EQ1:

where Pₘₐₓ is the maximum allowed UE transmission power (e.g. 23 dBm), M is the bandwidth of the PUSCH resource assignment in RBs, P₀ is power offset, α={0, 0.4, 0.5, 0.6, 0.7, 0.8, 0.9, 1} degree of path loss compensation, PL is path loss estimated from the received reference signal, Δ_{TF} is transport dependent offset for various modulation and coding schemes, Δᵢ is closed loop power correction. The path loss PL may be determined from higher layer filtered RSRP measurements using CRS and “Reference Signal Power” signaled in a system information block 2 (SIB2) message.

For SRS the transmit power (in dBm) is set by the UE according the following equation:

P_{SRS}=min(Pₘₐₓ,P_{SRS}_{_}_{OFFSET}+10 log₁₀M_{SRS}+P₀+α·PL+Δᵢ) EQ2:

where Pₘₐₓ is the maximum allowed UE transmission power (e.g. 23 dBm), M_{SRS} is the bandwidth of the SRS in RBs, P₀ is power offset, α={0, 0.4, 0.5, 0.6, 0.7, 0.8, 0.9, 1} degree of path loss compensation, PL is path loss estimated from the received reference signal, Δᵢ is closed loop power correction and P_{SRS}_{_}_{OFFSET} is higher layer configured power offset parameter.

Existing techniques for OLPC are based on PL estimation from CRS that may not have support of FD MIMO pre-coding such as elevation beamforming Systems and methods described herein address this issue by utilizing DRS signals for power control measurement. More particularly, in accordance with subject matter described herein, an eNB may configure a DRS that may be used by a UE for the PL estimation instead of CRS. In addition, the eNB can signal using higher layer signaling the DRS reference signal power and a power boosting parameter (P) if applicable. For example, the reference signal power associated with the CSI-RS corresponding to the configured DRS may be provided to the UE via higher layer signaling. Based on the reference signal power information and RSRP estimation from the DRS measurement, a UE may estimate a PL parameter by subtracting RSRP from the reference signal power. The PL parameter estimated from DRS may be used in the conventional power control procedures for PUSCH, PUCCH and SRS taking into account the FD-MIMO pre-coding or beamforming.

In some examples, at least two DRS may be configured for PL measurements. In such embodiment, the actual PL that is measured on one of the configured DRS that should be used to determine the transmission power in the uplink may be determined by the UE from the eNB signaling such as DCI for aperiodic SRS transmission or PUSCH grant.

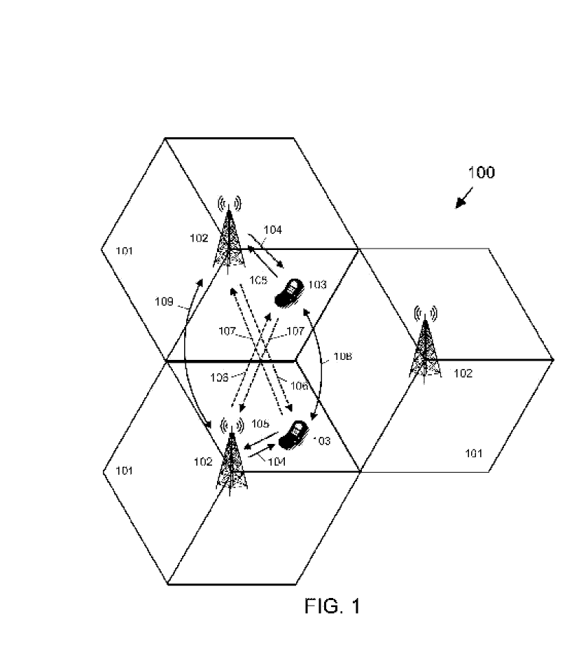

Additional features and characteristics these techniques and communication systems in which the techniques may be incorporated are described below with reference to FIGS. 1-10.

FIG. 1 is a schematic, block diagram illustration of an exemplary communication system 100, and the signals that are useful and the signals that cause interference that are associated with system 100. System 100 comprises a plurality of cells 101, of which only three cells are shown and that are represented by hexagonal shapes. Each cell 101 can have one or more sectors, which are represented as rhombuses within a hexagonal shape. It should be understood that a cell 101 and/or a sector respectively can and do in reality have a shape different from a hexagon or a rhombus. Each cell 101 comprises at least one base station (BS) 102. A plurality of user equipment (UEs) 103 may be located throughout system 100, although only two UEs are shown.

A base station 102 can be embodied as, but is not limited to, an evolved NodeB (eNB or eNodeB), a macro-cell base station, a pico-cell base station, a femto-cell base station, or the like. A user equipment 103 can embodied as, but is not limited to, a mobile station (MS), a subscriber station (SS), a Machine-to-Machine-type (M2M-type) device, customer premises equipment (CPE), a notebook-type computer, a tablet-type device, a cellular telephone, a smart-type device, a smartphone, a personal digital assistant, an information-handling system, or the like as described herein.

Useful downlink (DL) signals from a BS 102 to a UE 103 are indicated at 104. Useful uplink (UL) signals from a UE 103 to a BS 102 are indicated at 105. Interference signals 106 and 107 are represented by dashed lines in FIG. 1.

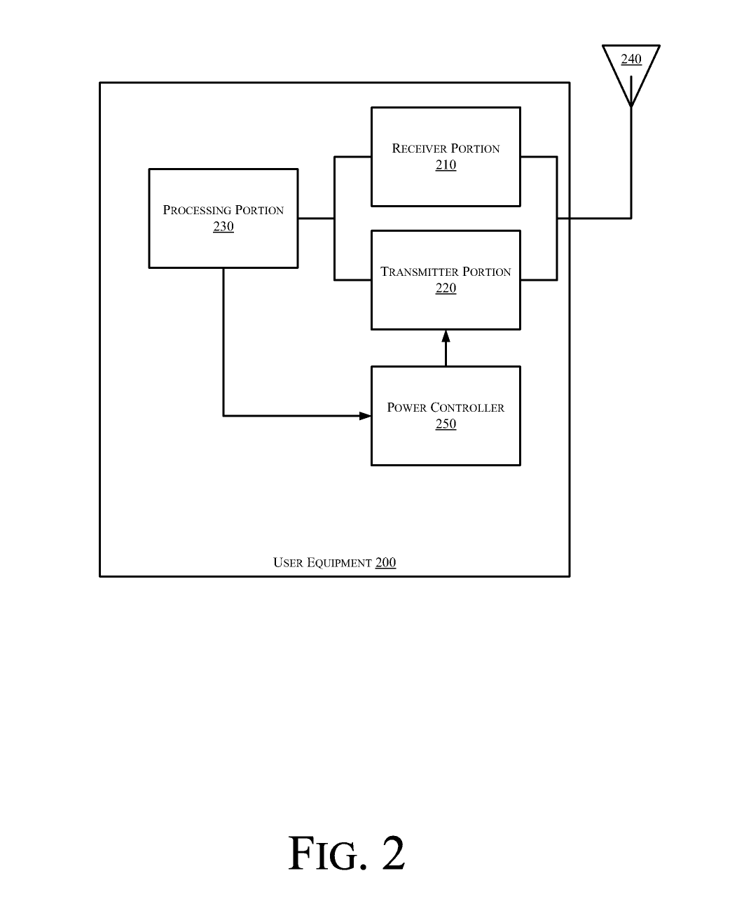

FIG. 2 is a schematic, block diagram illustration of a user equipment (UE) 200 according to the subject matter disclosed herein. User equipment 200 comprises a receiver portion 210, a transmitter portion 220, a processing portion 230, an antenna 240, and a power controller 250. Receiver portion 210 and transmitter portion 220 are coupled in a well-known manner to processing portion 230 and to one or more antennas 240. In some examples, processing portion 230 evaluates one or more aspects of a discovery reference signal (DRS) received by receiver portion 210 to provide feedback to power controller 250. In response to the feedback from processing portion, 230, power controller 250, which is coupled to transmitter portion 220, controls the UL transmit power output from transmitter portion 220.

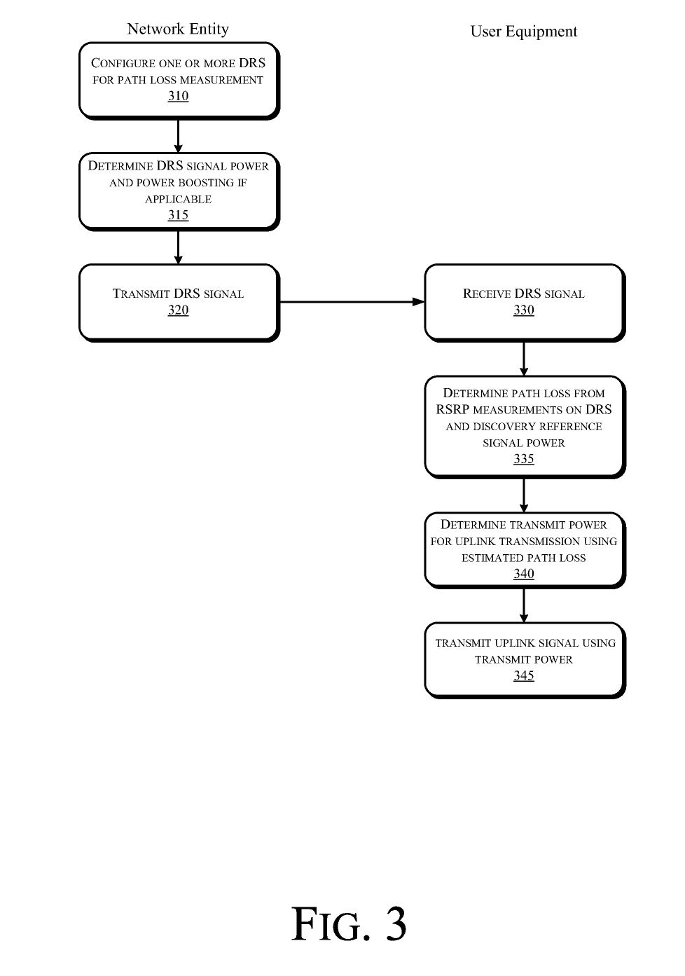

FIG. 3 is a flowchart illustrating high-level operations in a method to implement DRS based power control in communication systems in accordance with various examples discussed herein. In some examples some of the operations depicted in FIG. 3 may be implemented by a processing device embedded in a network entity, e.g., a processor in an eNB such as one of the base stations 102 depicted in FIG. 1, while some operations may be implemented by user equipment (UE), e.g., a processor in a device such as user equipment 103

Referring to FIG. 3, at operation 310 an network entity configures one or more DRS for path loss measurement. In some examples configuring the DRS may include configuring a CSI-RS, a CRS, or combinations thereof. Further, in some examples configuring the DRS may include determining the reference signal transmit power associated with the DRS.

At operation 315 the network entity determines a DRS power setting and open loop power control parameters. In some examples the DRS power setting may be additionally increased (i.e., boosted) to provide a stronger DRS signal. In some examples the power boosting on DRS (e.g. on CSI-RS) may be used to ensure more accurate DRS-based measurement within the coverage area of the eNB. The power boosting of DRS may be accounted in the reference signal power. At operation 320 the network entity transmits the DRS signal in accordance to DRS configuration. Further, in some examples the DRS power setting determined in operation 315 may be transmitted in higher-level signaling, e.g., in RRC signaling.

At operation 330 the UE receives the DRS signal transmitted by the network entity. At operation 335 the UE calculates the path loss from RSRP measurements on the DRS signal (e.g. RSRP is calculated using CSI-RS of DRS) and the discovery reference transmit power setting determined in operation 315 and transmitted in operation 320. In some examples the path loss is determined by subtracting the estimated RSRP parameter on the received DRS (e.g. RSRP estimated from the received CSI-RS of DRS) from a reference signal transmitted power parameter associated with the DRS (e.g. reference signal power for CSI-RS of DRS).

At operation 340 the UE using equation 1 or 2 determines a transmit power for the uplink transmission using the estimated path loss in operation 335 and higher layer configured OLPC parameters. And at operation 345 the UE transmits an uplink signal using the transmit power determined in operation 340.

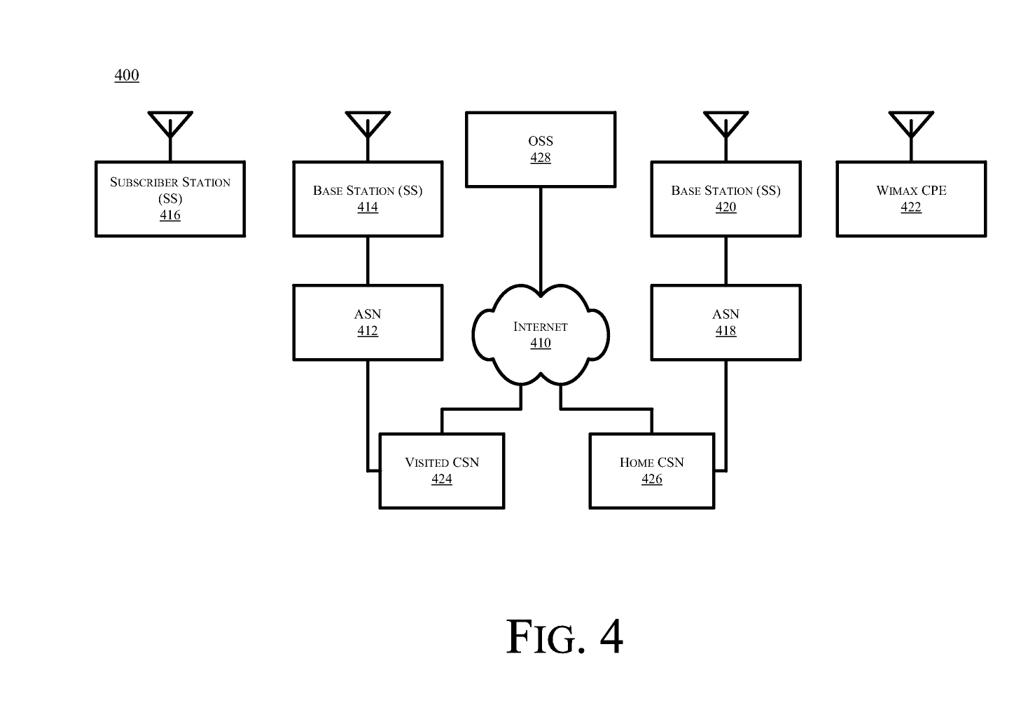

FIG. 4 is a schematic, block diagram illustration of a wireless network 400 in accordance with one or more exemplary embodiments disclosed herein. One or more of the elements of wireless network 400 may be capable of implementing methods to identify victims and aggressors according to the subject matter disclosed herein. As shown in FIG. 4, network 400 may be an Internet-Protocol-type (IP-type) network comprising an Internet-type network 410, or the like, that is capable of supporting mobile wireless access and/or fixed wireless access to Internet 410.

In one or more examples, network 400 may operate in compliance with a Worldwide Interoperability for Microwave Access (WiMAX) standard or future generations of WiMAX, and in one particular example may be in compliance with an Institute for Electrical and Electronics Engineers 802.16-based standard (for example, IEEE 802.16e), or an IEEE 802.11-based standard (for example, IEEE 802.11 a/b/g/n standard), and so on. In one or more alternative examples, network 400 may be in compliance with a 3rd Generation Partnership Project Long Term Evolution (3GPP LTE), a 3GPP2 Air Interface Evolution (3GPP2 AIE) standard and/or a 3GPP LTE-Advanced standard. In general, network 400 may comprise any type of orthogonal-frequency-division-multiple-access-based (OFDMA-based) wireless network, for example, a WiMAX compliant network, a Wi-Fi Alliance Compliant Network, a digital subscriber-line-type (DSL-type) network, an asymmetric-digital-subscriber-line-type (ADSL-type) network, an Ultra-Wideband (UWB) compliant network, a Wireless Universal Serial Bus (USB) compliant network, a 4th Generation (4G) type network, and so on, and the scope of the claimed subject matter is not limited in these respects.

As an example of mobile wireless access, access service network (ASN) 412 is capable of coupling with base station (BS) 414 to provide wireless communication between subscriber station (SS) 416 (also referred to herein as a wireless terminal) and Internet 410. In one example, subscriber station 416 may comprise a mobile-type device or information-handling system capable of wirelessly communicating via network 400, for example, a notebook-type computer, a cellular telephone, a personal digital assistant, an M2M-type device, or the like. In another example, subscriber station is capable of providing an uplink-transmit-power control technique that reduces interference experienced at other user equipments according to the subject matter disclosed herein. ASN 412 may implement profiles that are capable of defining the mapping of network functions to one or more physical entities on network 400. Base station 414 may comprise radio equipment to provide radio-frequency (RF) communication with subscriber station 416, and may comprise, for example, the physical layer (PHY) and media access control (MAC) layer equipment in compliance with an IEEE 802.16e-type standard. Base station 414 may further comprise an IP backplane to couple to Internet 410 via ASN 412, although the scope of the claimed subject matter is not limited in these respects.

Network 400 may further comprise a visited connectivity service network (CSN) 424 capable of providing one or more network functions including, but not limited to, proxy and/or relay type functions, for example, authentication, authorization and accounting (AAA) functions, dynamic host configuration protocol (DHCP) functions, or domain-name service controls or the like, domain gateways, such as public switched telephone network (PSTN) gateways or Voice over Internet Protocol (VoIP) gateways, and/or Internet-Protocol-type (IP-type) server functions, or the like. These are, however, merely example of the types of functions that are capable of being provided by visited CSN or home CSN 426, and the scope of the claimed subject matter is not limited in these respects.

Visited CSN 424 may be referred to as a visited CSN in the case, for example, in which visited CSN 424 is not part of the regular service provider of subscriber station 416, for example, in which subscriber station 416 is roaming away from its home CSN, such as home CSN 426, or, for example, in which network 400 is part of the regular service provider of subscriber station, but in which network 400 may be in another location or state that is not the main or home location of subscriber station 416.

In a fixed wireless arrangement, WiMAX-type customer premises equipment (CPE) 422 may be located in a home or business to provide home or business customer broadband access to Internet 410 via base station 420, ASN 418, and home CSN 426 in a manner similar to access by subscriber station 416 via base station 414, ASN 412, and visited CSN 424, a difference being that WiMAX CPE 422 is generally disposed in a stationary location, although it may be moved to different locations as needed, whereas subscriber station may be utilized at one or more locations if subscriber station 416 is within range of base station 414 for example.

It should be noted that CPE 422 need not necessarily comprise a WiMAX-type terminal, and may comprise other types of terminals or devices compliant with one or more standards or protocols, for example, as discussed herein, and in general may comprise a fixed or a mobile device. Moreover, in one exemplary embodiment, CPE 422 is capable of providing an uplink-transmit-power control technique that reduces interference experienced at other user equipments according to the subject matter disclosed herein.

In accordance with one or more examples, operation support system (OSS) 428 may be part of network 400 to provide management functions for network 400 and to provide interfaces between functional entities of network 400. Network 400 of FIG. 4 is merely one type of wireless network showing a certain number of the components of network 400; however, the scope of the claimed subject matter is not limited in these respects.

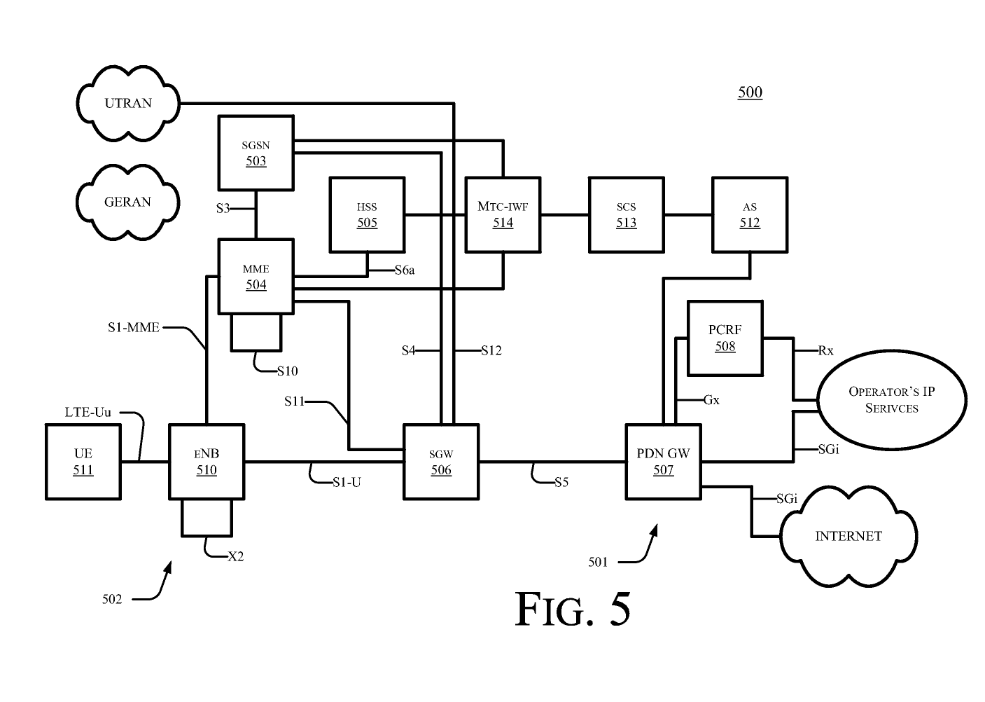

FIG. 5 shows an exemplary block diagram of the overall architecture of a 3GPP LTE network 500 that includes one or more devices that are capable of implementing methods to identify victims and aggressors according to the subject matter disclosed herein. FIG. 5 also generally shows exemplary network elements and exemplary standardized interfaces. At a high level, network 500 comprises a core network (CN) 501 (also referred to as an evolved Packet System (EPC)), and an air-interface access network E UTRAN 502. CN 501 is responsible for the overall control of the various User Equipment (UE) connected to the network and establishment of the bearers. CN 501 may include functional entities, such as a home agent and/or an ANDSF server or entity, although not explicitly depicted. E UTRAN 502 is responsible for all radio-related functions.

The main exemplary logical nodes of CN 501 include, but are not limited to, a Serving GPRS Support Node 503, the Mobility Management Entity 504, a Home Subscriber Server (HSS) 505, a Serving Gate (SGW) 506, a PDN Gateway 507 and a Policy and Charging Rules Function (PCRF) Manager 508. The functionality of each of the network elements of CN 501 is well known and is not described herein. Each of the network elements of CN 501 are interconnected by well-known exemplary standardized interfaces, some of which are indicated in FIG. 5, such as interfaces S3, S4, S5, etc., although not described herein.

While CN 501 includes many logical nodes, the E UTRAN access network 502 is formed by at least one node, such as evolved NodeB (base station (BS), eNB or eNodeB) 510, which connects to one or more User Equipment (UE) 511, of which only one is depicted in FIG. 5. UE 511 is also referred to herein as a user equipment (UE) and/or a subscriber station (SS), and can include an M2M-type device. In one EXAMPLE, UE 511 is capable of providing an uplink-transmit-power control technique that reduces interference experienced at other user equipments according to the subject matter disclosed herein. In one exemplary configuration, a single cell of an E UTRAN access network 502 provides one substantially localized geographical transmission point (having multiple antenna devices) that provides access to one or more UEs. In another exemplary configuration, a single cell of an E UTRAN access network 502 provides multiple geographically substantially isolated transmission points (each having one or more antenna devices) with each transmission point providing access to one or more UEs simultaneously and with the signaling bits defined for the one cell so that all UEs share the same spatial signaling dimensioning. For normal user traffic (as opposed to broadcast), there is no centralized controller in E-UTRAN; hence the E-UTRAN architecture is said to be flat. The eNBs are normally interconnected with each other by an interface known as “X2” and to the EPC by an S1 interface. More specifically, an eNB is connected to MME 504 by an S1 MME interface and to SGW 506 by an S1 U interface. The protocols that run between the eNBs and the UEs are generally referred to as the “AS protocols.” Details of the various interfaces are well known and not described herein.

The eNB 510 hosts the PHYsical (PHY), Medium Access Control (MAC), Radio Link Control (RLC), and Packet Data Control Protocol (PDCP) layers, which are not shown in FIG. 5, and which include the functionality of user-plane header-compression and encryption. The eNB 510 also provides Radio Resource Control (RRC) functionality corresponding to the control plane, and performs many functions including radio resource management, admission control, scheduling, enforcement of negotiated Up Link (UL) QoS, cell information broadcast, ciphering/deciphering of user and control plane data, and compression/decompression of DL/UL user plane packet headers.

The RRC layer in eNB 510 covers all functions related to the radio bearers, such as radio bearer control, radio admission control, radio mobility control, scheduling and dynamic allocation of resources to UEs in both uplink and downlink, header compression for efficient use of the radio interface, security of all data sent over the radio interface, and connectivity to the EPC. The RRC layer makes handover decisions based on neighbor cell measurements sent by UE 511, generates pages for UEs 511 over the air, broadcasts system information, controls UE measurement reporting, such as the periodicity of Channel Quality Information (CQI) reports, and allocates cell-level temporary identifiers to active UEs 511. The RRC layer also executes transfer of UE context from a source eNB to a target eNB during handover, and provides integrity protection for RRC messages. Additionally, the RRC layer is responsible for the setting up and maintenance of radio bearers.

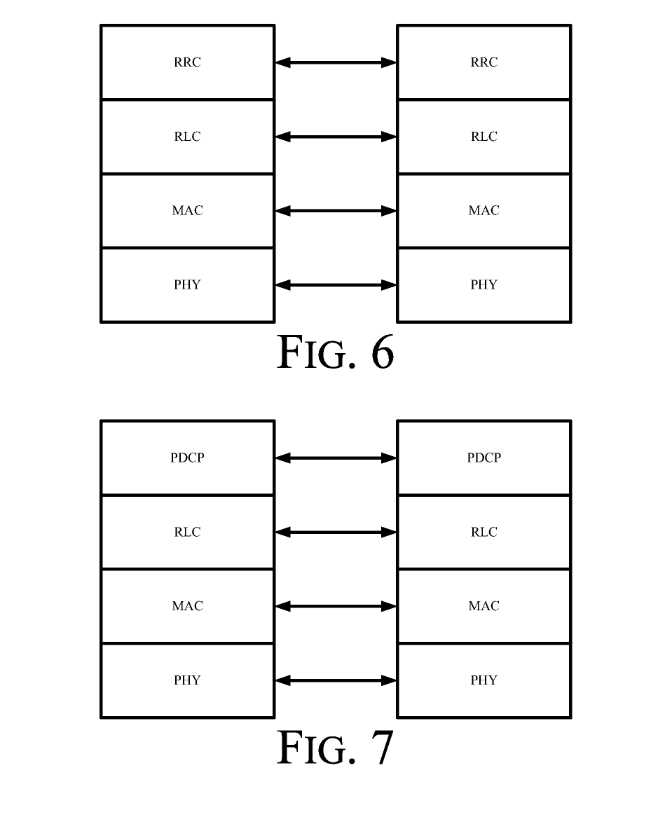

FIGS. 6 and 7 respectively depict exemplary radio interface protocol structures between a UE and an eNodeB that are based on a 3GPP-type radio access network standard and that is capable of providing an uplink-transmit-power control technique that reduces interference experienced at other user equipments according to the subject matter disclosed herein. More specifically, FIG. 6 depicts individual layers of a radio protocol control plane and FIG. 7 depicts individual layers of a radio protocol user plane. The protocol layers of FIGS. 6 and 7 can be classified into an L1 layer (first layer), an L2 layer (second layer) and an L3 layer (third layer) on the basis of the lower three layers of the OSI reference model widely known in communication systems.

The physical (PHY) layer, which is the first layer (L1), provides an information transfer service to an upper layer using a physical channel. The physical layer is connected to a Medium Access Control (MAC) layer, which is located above the physical layer, through a transport channel. Data is transferred between the MAC layer and the PHY layer through the transport channel. A transport channel is classified into a dedicated transport channel and a common transport channel according to whether or not the channel is shared. Data transfer between different physical layers, specifically between the respective physical layers of a transmitter and a receiver is performed through the physical channel.

A variety of layers exist in the second layer (L2 layer). For example, the MAC layer maps various logical channels to various transport channels, and performs logical-channel multiplexing for mapping various logical channels to one transport channel. The MAC layer is connected to the Radio Link Control (RLC) layer serving as an upper layer through a logical channel. The logical channel can be classified into a control channel for transmitting information of a control plane and a traffic channel for transmitting information of a user plane according to categories of transmission information.

The RLC layer of the second layer (L2) performs segmentation and concatenation on data received from an upper layer, and adjusts the size of data to be suitable for a lower layer transmitting data to a radio interval. In order to guarantee various Qualities of Service (QoSs) requested by respective radio bearers (RBs), three operation modes, i.e., a Transparent Mode (TM), an Unacknowledged Mode (UM), and an Acknowledged Mode (AM), are provided. Specifically, an AM RLC performs a retransmission function using an Automatic Repeat and Request (ARQ) function so as to implement reliable data transmission.

A Packet Data Convergence Protocol (PDCP) layer of the second layer (L2) performs a header compression function to reduce the size of an IP packet header having relatively large and unnecessary control information in order to efficiently transmit IP packets, such as IPv4 or IPv6 packets, in a radio interval with a narrow bandwidth. As a result, only information required for a header part of data can be transmitted, so that transmission efficiency of the radio interval can be increased. In addition, in an LTE-based system, the PDCP layer performs a security function that includes a ciphering function for preventing a third party from eavesdropping on data and an integrity protection function for preventing a third party from handling data.

A Radio Resource Control (RRC) layer located at the top of the third layer (L3) is defined only in the control plane and is responsible for control of logical, transport, and physical channels in association with configuration, re-configuration and release of Radio Bearers (RBs). The RB is a logical path that the first and second layers (L1 and L2) provide for data communication between the UE and the UTRAN. Generally, Radio Bearer (RB) configuration means that a radio protocol layer needed for providing a specific service, and channel characteristics are defined and their detailed parameters and operation methods are configured. The Radio Bearer (RB) is classified into a Signaling RB (SRB) and a Data RB (DRB). The SRB is used as a transmission passage of RRC messages in the C plane, and the DRB is used as a transmission passage of user data in the U plane.

A downlink transport channel for transmitting data from the network to the UE may be classified into a Broadcast Channel (BCH) for transmitting system information and a downlink Shared Channel (SCH) for transmitting user traffic or control messages. Traffic or control messages of a downlink multicast or broadcast service may be transmitted through a downlink SCH and may also be transmitted through a downlink multicast channel (MCH). Uplink transport channels for transmission of data from the UE to the network include a Random Access Channel (RACH) for transmission of initial control messages and an uplink SCH for transmission of user traffic or control messages.

Downlink physical channels for transmitting information transferred to a downlink transport channel to a radio interval between the UE and the network are classified into a Physical Broadcast Channel (PBCH) for transmitting BCH information, a Physical Multicast Channel (PMCH) for transmitting MCH information, a Physical Downlink Shared Channel (PDSCH) for transmitting downlink SCH information, and a Physical Downlink Control Channel (PDCCH) (also called a DL L1/L2 control channel) for transmitting control information, such as DL/UL Scheduling Grant information, received from first and second layers (L1 and L2). In the meantime, uplink physical channels for transmitting information transferred to an uplink transport channel to a radio interval between the UE and the network are classified into a Physical Uplink Shared Channel (PUSCH) for transmitting uplink SCH information, a Physical Random Access Channel for transmitting RACH information, and a Physical Uplink Control Channel (PUCCH) for transmitting control information, such as Hybrid Automatic Repeat Request (HARQ) ACK or NACK Scheduling Request (SR) and Channel Quality Indicator (CQI) report information, received from first and second layers (L1 and L2).

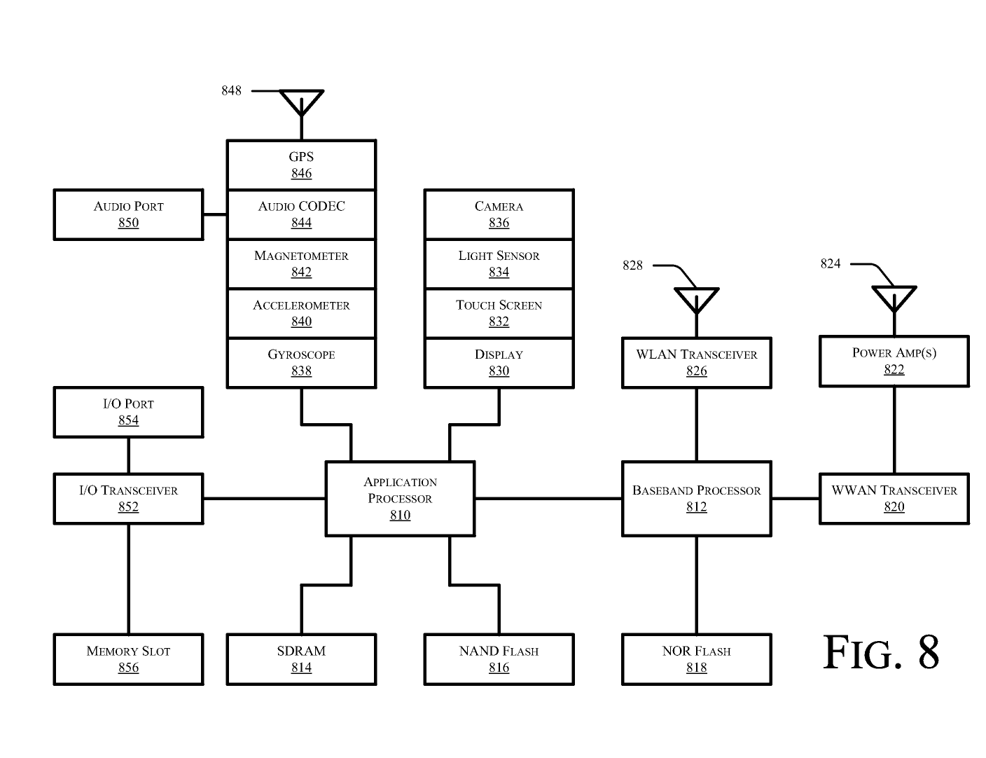

FIG. 8 depicts an exemplary functional block diagram of an information-handling system 800 that is capable of implementing methods to identify victims and aggressors according to the subject matter disclosed herein. Information handling system 800 of FIG. 8 may tangibly embody one or more of any of the exemplary devices, exemplary network elements and/or functional entities of the network as shown in and described herein. In one example, information-handling system 800 may represent the components of user equipment 200, subscriber station 616, CPE 622, base stations 614 and 620, eNB 510, and/or UE 511, with greater or fewer components depending on the hardware specifications of the particular device or network element. In another example, information-handling system may provide M2M-type device capability. In yet another exemplary embodiment, information-handling system 800 is capable of providing an uplink-transmit-power control technique that reduces interference experienced at other user equipments according to the subject matter disclosed herein. Although information-handling system 800 represents one example of several types of computing platforms, information-handling system 800 may include more or fewer elements and/or different arrangements of elements than shown in FIG. 6, and the scope of the claimed subject matter is not limited in these respects.

In one or more examples, information-handling system 800 may comprise one or more applications processor 810 and a baseband processor 812. Applications processor 810 may be utilized as a general purpose processor to run applications and the various subsystems for information handling system 800, and to capable of providing an uplink-transmit-power control technique that reduces interference experienced at other user equipments according to the subject matter disclosed herein. Applications processor 810 may include a single core or alternatively may include multiple processing cores wherein one or more of the cores may comprise a digital signal processor or digital signal processing core. Furthermore, applications processor 810 may include a graphics processor or coprocessor disposed on the same chip, or alternatively a graphics processor coupled to applications processor 810 may comprise a separate, discrete graphics chip. Applications processor 810 may include on-board memory, such as cache memory, and further may be coupled to external memory devices such as synchronous dynamic random access memory (SDRAM) 814 for storing and/or executing applications, such as capable of providing an uplink-transmit-power control technique that reduces interference experienced at other user equipments according to the subject matter disclosed herein. During operation, and NAND flash 816 for storing applications and/or data even when information handling system 800 is powered off.

In one example, a list of candidate nodes may be stored in SDRAM 814 and/or NAND flash 816. Further, applications processor 810 may execute computer-readable instructions stored in SDRAM 814 and/or NAND flash 816 that result in an uplink-transmit-power control technique that reduces interference experienced at other user equipments according to the subject matter disclosed herein.

In one example, baseband processor 812 may control the broadband radio functions for information-handling system 800. Baseband processor 812 may store code for controlling such broadband radio functions in a NOR flash 818. Baseband processor 812 controls a wireless wide area network (WWAN) transceiver 820 which is used for modulating and/or demodulating broadband network signals, for example, for communicating via a 3GPP LTE network or the like as discussed herein with respect to FIG. 8. The WWAN transceiver 820 couples to one or more power amplifiers 822 that are respectively coupled to one or more antennas 824 for sending and receiving radio-frequency signals via the WWAN broadband network. The baseband processor 812 also may control a wireless local area network (WLAN) transceiver 826 coupled to one or more suitable antennas 828 and that may be capable of communicating via a Bluetooth-based standard, an IEEE 802.11-based standard, an IEEE 802.16-based standard, an IEEE 802.18-based wireless network standard, a 3GPP-based protocol wireless network, a Third Generation Partnership Project Long Term Evolution (3GPP LTE) based wireless network standard, a 3GPP2 Air Interface Evolution (3GPP2 AIE) based wireless network standard, a 3GPP-LTE-Advanced-based wireless network, a UMTS-based protocol wireless network, a CDMA2000-based protocol wireless network, a GSM-based protocol wireless network, a cellular-digital-packet-data-based (CDPD-based) protocol wireless network, a Mobitex-based protocol wireless network, a Near-Field-Communications-based (NFC-based) link, a WiGig-based network, a ZigBee-based network, or the like. It should be noted that these are merely exemplary implementations for applications processor 810 and baseband processor 812, and the scope of the claimed subject matter is not limited in these respects. For example, any one or more of SDRAM 814, NAND flash 816 and/or NOR flash 818 may comprise other types of memory technology, such as magnetic-based memory, chalcogenide-based memory, phase-change-based memory, optical-based memory, or ovonic-based memory, and the scope of the claimed subject matter is not limited in this respect.

In one or more embodiments, applications processor 810 may drive a display 830 for displaying various information or data, and may further receive touch input from a user via a touch screen 832, for example, via a finger or a stylus. In one exemplary embodiment, screen 832 display a menu and/or options to a user that are selectable via a finger and/or a stylus for entering information into information-handling system 800.

An ambient light sensor 834 may be utilized to detect an amount of ambient light in which information-handling system 800 is operating, for example, to control a brightness or contrast value for display 830 as a function of the intensity of ambient light detected by ambient light sensor 834. One or more cameras 836 may be utilized to capture images that are processed by applications processor 810 and/or at least temporarily stored in NAND flash 816. Furthermore, applications processor may be coupled to a gyroscope 838, accelerometer 840, magnetometer 842, audio coder/decoder (CODEC) 844, and/or global positioning system (GPS) controller 846 coupled to an appropriate GPS antenna 848, for detection of various environmental properties including location, movement, and/or orientation of information-handling system 800. Alternatively, controller 846 may comprise a Global Navigation Satellite System (GNSS) controller. Audio CODEC 844 may be coupled to one or more audio ports 850 to provide microphone input and speaker outputs either via internal devices and/or via external devices coupled to information-handling system via the audio ports 850, for example, via a headphone and microphone jack. In addition, applications processor 810 may couple to one or more input/output (I/O) transceivers 852 to couple to one or more I/O ports 854 such as a universal serial bus (USB) port, a high-definition multimedia interface (HDMI) port, a serial port, and so on. Furthermore, one or more of the I/O transceivers 852 may couple to one or more memory slots 856 for optional removable memory, such as secure digital (SD) card or a subscriber identity module (SIM) card, although the scope of the claimed subject matter is not limited in these respects.

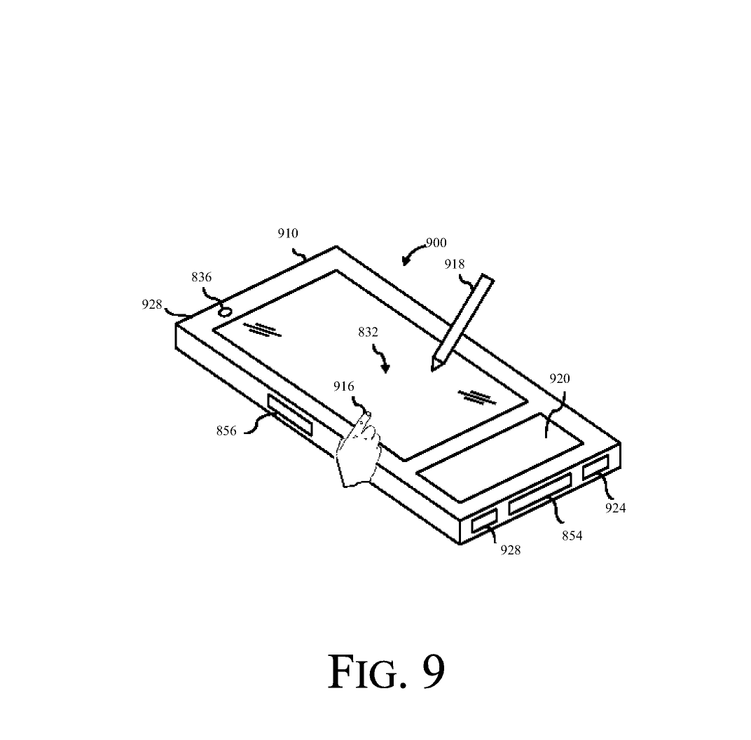

FIG. 9 depicts an isometric view of an exemplary embodiment of the information-handling system of FIG. 8 that optionally may include a touch screen in accordance with one or more embodiments disclosed herein. FIG. 9 shows an example implementation of information-handling system 800 of FIG. 8 tangibly embodied as a cellular telephone, smartphone, smart-type device, or tablet-type device or the like, that is capable of implementing methods to identify victims and aggressors according to the subject matter disclosed herein. In one or more embodiments, the information-handling system 800 may comprise any one of the infrastructure nodes, user equipment 400, subscriber station 616, CPE 622, mobile station UE 511 of FIG. 5, and/or an M2M-type device, although the scope of the claimed subject matter is not limited in this respect. The information-handling system 800 may comprise a housing 910 having a display 830 that may include a touch screen 832 for receiving tactile input control and commands via a finger 916 of a user and/or a via stylus 918 to control one or more applications processors 810. The housing 910 may house one or more components of information-handling system 800, for example, one or more applications processors 810, one or more of SDRAM 814, NAND flash 816, NOR flash 818, baseband processor 812, and/or WWAN transceiver 820. The information-handling system 800 further may optionally include a physical actuator area 920 which may comprise a keyboard or buttons for controlling information-handling system 800 via one or more buttons or switches. The information-handling system 800 may also include a memory port or slot 856 for receiving non-volatile memory, such as flash memory, for example, in the form of a secure digital (SD) card or a subscriber identity module (SIM) card. Optionally, the information-handling system 800 may further include one or more speakers and/or microphones 924 and a connection port 854 for connecting the information-handling system 800 to another electronic device, dock, display, battery charger, and so on. Additionally, information-handling system 800 may include a headphone or speaker jack 928 and one or more cameras 836 on one or more sides of the housing 910. It should be noted that the information-handling system 800 of FIGS. 8 and 9 may include more or fewer elements than shown, in various arrangements, and the scope of the claimed subject matter is not limited in this respect.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

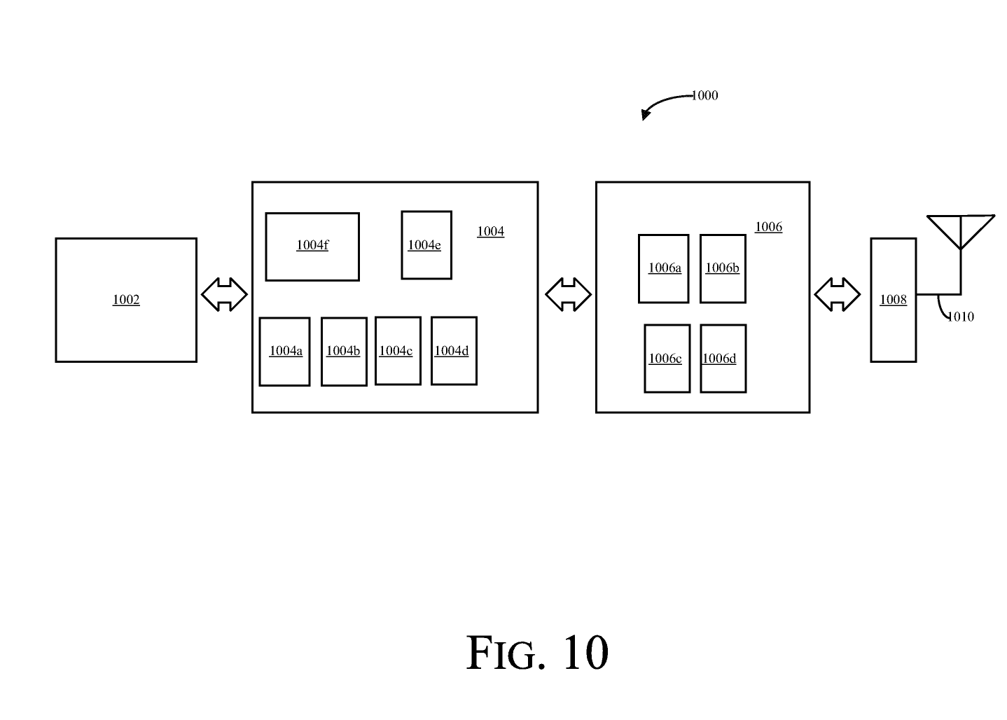

Embodiments described herein may be implemented into a system using any suitably configured hardware and/or software. FIG. 10 illustrates, for one embodiment, example components of a User Equipment (UE) device 1000. In some embodiments, the UE device 1000 may include application circuitry 1002, baseband circuitry 1004, Radio Frequency (RF) circuitry 1006, front-end module (FEM) circuitry 1008 and one or more antennas 1010, coupled together at least as shown.

The application circuitry 1002 may include one or more application processors. For example, the application circuitry 1002 may include circuitry such as, but not limited to, one or more single-core or multi-core processors. The processor(s) may include any combination of general-purpose processors and dedicated processors (e.g., graphics processors, application processors, etc.). The processors may be coupled with and/or may include memory/storage and may be configured to execute instructions stored in the memory/storage to enable various applications and/or operating systems to run on the system.

The baseband circuitry 1004 may include circuitry such as, but not limited to, one or more single-core or multi-core processors. The baseband circuitry 1004 may include one or more baseband processors and/or control logic to process baseband signals received from a receive signal path of the RF circuitry 1006 and to generate baseband signals for a transmit signal path of the RF circuitry 1006. Baseband processing circuitry 1004 may interface with the application circuitry 1002 for generation and processing of the baseband signals and for controlling operations of the RF circuitry 1006. For example, in some embodiments, the baseband circuitry 1004 may include a second generation (2G) baseband processor 1004a, third generation (3G) baseband processor 1004b, fourth generation (4G) baseband processor 1004c, and/or other baseband processor(s) 1004d for other existing generations, generations in development or to be developed in the future (e.g., fifth generation (5G), 6G, etc.). The baseband circuitry 1004 (e.g., one or more of baseband processors 1004a-d) may handle various radio control functions that enable communication with one or more radio networks via the RF circuitry 1006. The radio control functions may include, but are not limited to, signal modulation/demodulation, encoding/decoding, radio frequency shifting, etc. In some embodiments, modulation/demodulation circuitry of the baseband circuitry 1004 may include Fast-Fourier Transform (FFT), precoding, and/or constellation mapping/demapping functionality. In some embodiments, encoding/decoding circuitry of the baseband circuitry 1004 may include convolution, tail-biting convolution, turbo, Viterbi, and/or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1004 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), and/or radio resource control (RRC) elements. A central processing unit (CPU) 1004e of the baseband circuitry 1004 may be configured to run elements of the protocol stack for signaling of the PHY, MAC, RLC, PDCP and/or RRC layers. In some embodiments, the baseband circuitry may include one or more audio digital signal processor(s) (DSP) 1004f. The audio DSP(s) 1004f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1004 and the application circuitry 1002 may be implemented together such as, for example, on a system on a chip (SOC).

In some embodiments, the baseband circuitry 1004 may provide for communication compatible with one or more radio technologies. For example, in some embodiments, the baseband circuitry 1004 may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry 1004 is configured to support radio communications of more than one wireless protocol may be referred to as multi-mode baseband circuitry.

RF circuitry 1006 may enable communication with wireless networks using modulated electromagnetic radiation through a non-solid medium. In various embodiments, the RF circuitry 1006 may include switches, filters, amplifiers, etc. to facilitate the communication with the wireless network. RF circuitry 1006 may include a receive signal path which may include circuitry to down-convert RF signals received from the FEM circuitry 1008 and provide baseband signals to the baseband circuitry 1004. RF circuitry 1006 may also include a transmit signal path which may include circuitry to up-convert baseband signals provided by the baseband circuitry 1004 and provide RF output signals to the FEM circuitry 1008 for transmission.

In some embodiments, the RF circuitry 1006 may include a receive signal path and a transmit signal path. The receive signal path of the RF circuitry 1006 may include mixer circuitry 1006a, amplifier circuitry 1006b and filter circuitry 1006c. The transmit signal path of the RF circuitry 1006 may include filter circuitry 1006c and mixer circuitry 1006a. RF circuitry 1006 may also include synthesizer circuitry 1006d for synthesizing a frequency for use by the mixer circuitry 1006a of the receive signal path and the transmit signal path. In some embodiments, the mixer circuitry 1006a of the receive signal path may be configured to down-convert RF signals received from the FEM circuitry 1008 based on the synthesized frequency provided by synthesizer circuitry 1006d. The amplifier circuitry 1006b may be configured to amplify the down-converted signals and the filter circuitry 1006c may be a low-pass filter (LPF) or band-pass filter (BPF) configured to remove unwanted signals from the down-converted signals to generate output baseband signals. Output baseband signals may be provided to the baseband circuitry 1004 for further processing. In some embodiments, the output baseband signals may be zero-frequency baseband signals, although this is not a requirement. In some embodiments, mixer circuitry 1006a of the receive signal path may comprise passive mixers, although the scope of the embodiments is not limited in this respect.

In some embodiments, the mixer circuitry 1006a of the transmit signal path may be configured to up-convert input baseband signals based on the synthesized frequency provided by the synthesizer circuitry 1006d to generate RF output signals for the FEM circuitry 1008. The baseband signals may be provided by the baseband circuitry 1004 and may be filtered by filter circuitry 1006c. The filter circuitry 1006c may include a low-pass filter (LPF), although the scope of the embodiments is not limited in this respect.

In some embodiments, the mixer circuitry 1006a of the receive signal path and the mixer circuitry 1006a of the transmit signal path may include two or more mixers and may be arranged for quadrature downconversion and/or upconversion respectively. In some embodiments, the mixer circuitry 1006a of the receive signal path and the mixer circuitry 1006a of the transmit signal path may include two or more mixers and may be arranged for image rejection (e.g., Hartley image rejection). In some embodiments, the mixer circuitry 1006a of the receive signal path and the mixer circuitry 1006a may be arranged for direct downconversion and/or direct upconversion, respectively. In some embodiments, the mixer circuitry 1006a of the receive signal path and the mixer circuitry 1006a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1006 may include analog-to-digital converter (ADC) and digital-to-analog converter (DAC) circuitry and the baseband circuitry 1004 may include a digital baseband interface to communicate with the RF circuitry 1006.

In some dual-mode embodiments, a separate radio IC circuitry may be provided for processing signals for each spectrum, although the scope of the embodiments is not limited in this respect.

In some embodiments, the synthesizer circuitry 1006d may be a fractional-N synthesizer or a fractional N/N+1 synthesizer, although the scope of the embodiments is not limited in this respect as other types of frequency synthesizers may be suitable. For example, synthesizer circuitry 1006d may be a delta-sigma synthesizer, a frequency multiplier, or a synthesizer comprising a phase-locked loop with a frequency divider.

The synthesizer circuitry 1006d may be configured to synthesize an output frequency for use by the mixer circuitry 1006a of the RF circuitry 1006 based on a frequency input and a divider control input. In some embodiments, the synthesizer circuitry 1006d may be a fractional N/N+1 synthesizer.

In some embodiments, frequency input may be provided by a voltage controlled oscillator (VCO), although that is not a requirement. Divider control input may be provided by either the baseband circuitry 1004 or the applications processor 1002 depending on the desired output frequency. In some embodiments, a divider control input (e.g., N) may be determined from a look-up table based on a channel indicated by the applications processor 1002.

Synthesizer circuitry 1006d of the RF circuitry 1006 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1006d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1006 may include an IQ/polar converter.

FEM circuitry 1008 may include a receive signal path which may include circuitry configured to operate on RF signals received from one or more antennas 1010, amplify the received signals and provide the amplified versions of the received signals to the RF circuitry 1006 for further processing. FEM circuitry 1008 may also include a transmit signal path which may include circuitry configured to amplify signals for transmission provided by the RF circuitry 1006 for transmission by one or more of the one or more antennas 1010.

In some embodiments, the FEM circuitry 1008 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1006). The transmit signal path of the FEM circuitry 1008 may include a power amplifier (PA) to amplify input RF signals (e.g., provided by RF circuitry 1006), and one or more filters to generate RF signals for subsequent transmission (e.g., by one or more of the one or more antennas 1010.

In some embodiments, the UE device 1000 may include additional elements such as, for example, memory/storage, display, camera, sensor, and/or input/output (I/O) interface.

In a first non-limiting example a network entity comprises processing circuitry to configure at least one discovery reference signal (DRS) for path loss measurement, determine a discovery reference signal power setting, and transmit the discovery reference signal (DRS) via a wireless communication link. The network entity further comprises processing circuitry to configure at least one of a channel state information reference signal (CSI-RS) or a cell-specific reference signal (CRS) for DRS. The network entity further comprises processing circuitry to determine a transmit power for the at least one of a channel state information reference signal (CSI-RS) or a cell-specific reference signal (CRS). The network entity further comprises processing circuitry to determine a total transmit power for a plurality of resource elements associated with the discovery reference signal (DRS). The network entity further comprises processing circuitry to boost a power level of the discovery reference signal. The network entity further comprises processing circuitry to signal a reference transmit power of the DRS, CRS or CSI-RS.

In a second non-limiting example User Equipment (UE) comprises processing circuitry to receive a discovery reference signal (DRS), determine a path loss parameter from one or more DRS measurements, and determine a transmit power level for an uplink transmission using the path loss parameter. The user equipment further comprises processing circuitry to estimate a reference signal received power (RSRP) parameter for the DRS and determine the path los parameter by subtracting the estimated RSRP parameter for the DRS from a reference signal transmitted power parameter received with the DRS. The user equipment further comprises processing circuitry to initiate an uplink transmission at the transmit power level. In some examples the uplink transmission corresponds to at least one of a physical uplink shared channel (PUSCH) or a physical uplink control channel (PUCCH). In some examples the uplink transmission corresponds to a sounding reference signal (SRS).

In a third non-limiting example an article of manufacture comprises a non-transitory storage medium having instructions stored thereon that, when executed by a processor, configure the processor to configure at least one discovery reference signal (DRS) for path loss measurement, determine a discovery reference signal power setting and transmit the discovery reference signal (DRS) via a wireless communication link. The article of manufacture further comprises instructions stored on the non-transitory storage medium what, when executed by the processor, configure the processor to configure at least one of a channel state information reference signal (CSI-RS) or a cell-specific reference signal (CRS) for DRS. The article of manufacture further comprises instructions stored on the non-transitory storage medium what, when executed by the processor, configure the processor to determine a transmit power for the at least one of a channel state information reference signal (CSI-RS) or a cell-specific reference signal (CRS) of DRS. The article of manufacture further comprises instructions stored on the non-transitory storage medium what, when executed by the processor, configure the processor to determine a total transmit power for a plurality of resource elements associated with the discovery reference signal (DRS). The article of manufacture further comprises instructions stored on the non-transitory storage medium what, when executed by the processor, configure the processor to boost a power level of the discovery reference signal.

In a fourth non-limiting example an article of manufacture comprises a non-transitory storage medium having instructions stored thereon that, when executed by a processor, configure the processor to configure at least one discovery reference signal (DRS) for path loss measurement, determine a discovery reference signal power; and transmit the discovery reference signal via a wireless communication link. The article of manufacture further comprises instructions stored on the non-transitory storage medium what, when executed by the processor, configure the processor to estimate a reference signal received power (RSRP) parameter for the DRS, determine the path loss parameter by subtracting the estimated RSRP parameter for the DRS from a reference signal transmitted power parameter received with the DRS, and determine a transmit power level for an uplink transmission using the path loss parameter. The article of manufacture further comprises instructions stored on the non-transitory storage medium what, when executed by the processor, configure the processor to initiate an uplink transmission at the transmit power level. In some examples the uplink transmission corresponds to at least one of a physical uplink shared channel (PUSCH) or a physical uplink control channel (PUCCH). In some examples the uplink transmission corresponds to a sounding reference signal (SRS).

In a fifth non-limiting example a controller comprises logic, at least partially including hardware logic, to configure at least one discovery reference signal (DRS) for path loss measurement, determine a discovery reference signal power setting and transmit the discovery reference signal (DRS) via a wireless communication link. The controller further comprises logic, at least partially including hardware logic, to configure at least one of a channel state information reference signal (CSI-RS) or a cell-specific reference signal (CRS) for DRS. The controller further comprises logic, at least partially including hardware logic, to determine a transmit power for the at least one of a channel state information reference signal (CSI-RS) or a cell-specific reference signal (CRS) of DRS. The controller further comprises logic, at least partially including hardware logic, to determine a total transmit power for a plurality of resource elements associated with the discovery reference signal (DRS). The controller further comprises logic, at least partially including hardware logic, to boost a power level of the discovery reference signal.

In a sixth non-limiting example a controller comprises logic, at least partially including hardware logic, to configure at least one discovery reference signal (DRS) for path loss measurement, determine a discovery reference signal power, and transmit the discovery reference signal via a wireless communication link. The controller further logic, at least partially including hardware logic, to estimate a reference signal received power (RSRP) parameter for the DRS, determine the path loss parameter by subtracting the estimated RSRP parameter for the DRS from a reference signal transmitted power parameter received with the DRS and determine a transmit power level for an uplink transmission using the path loss parameter. The controller further comprises logic, at least partially including hardware logic, to initiate an uplink transmission at the transmit power level. In some examples the uplink transmission corresponds to at least one of a physical uplink shared channel (PUSCH) or a physical uplink control channel (PUCCH). In some examples the uplink transmission corresponds to a sounding reference signal (SRS).

In various examples, the operations discussed herein may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein.

Reference in the specification to “one example” or “an example” means that a particular feature, structure, or characteristic described in connection with the example may be included in at least an implementation. The appearances of the phrase “in one example” in various places in the specification may or may not be all referring to the same example.

Also, in the description and claims, the terms “coupled” and “connected,” along with their derivatives, may be used. In some examples, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

1. A network entity comprising processing circuitry to:
configure at least one discovery reference signal (DRS) for path loss measurement;
determine a discovery reference signal power setting; and
transmit the discovery reference signal (DRS) via a wireless communication link.

2. The network entity of claim 1, further comprising processing circuitry to:
configure at least one of a channel state information reference signal (CSI-RS) or a cell-specific reference signal (CRS) for DRS.

3. The network entity of claim 2, further comprising processing circuitry to determine a transmit power for the at least one of a channel state information reference signal (CSI-RS) or a cell-specific reference signal (CRS).

4. The network entity of claim 1, further comprising processing circuitry to:
determine a total transmit power for a plurality of resource elements associated with the discovery reference signal (DRS).

5. The network entity of claim 4, further comprising processing circuitry to:
boost a power level of the discovery reference signal.

6. The network entity of claim 2, further comprising processing circuitry to signal a reference transmit power of the DRS, CRS or CSI-RS.

7. User equipment (UE) comprising processing circuitry to:
receive a discovery reference signal (DRS);
determine a path loss parameter from one or more DRS measurements; and
determine a transmit power level for an uplink transmission using the path loss parameter.

8. The user equipment of claim 7, further comprising processing circuitry to:
estimate a reference signal received power (RSRP) parameter for the DRS; and
determine the path loss parameter by subtracting the estimated RSRP parameter for the DRS from a reference signal transmitted power parameter received with the DRS.

9. The user equipment of claim 7, further comprising processing circuitry to:
initiate an uplink transmission at the transmit power level.

10. The user equipment of claim 9, wherein the uplink transmission corresponds to at least one of a physical uplink shared channel (PUSCH) or a physical uplink control channel (PUCCH).

11. The user equipment of claim 9, wherein the uplink transmission corresponds to a sounding reference signal (SRS).

12. An article of manufacture comprising a non-transitory storage medium having instructions stored thereon that, when executed by a processor, configure the processor to:
configure at least one discovery reference signal (DRS) for path loss measurement;
determine a discovery reference signal power setting; and
transmit the discovery reference signal (DRS) via a wireless communication link.

13. The article of manufacture of claim 12, further comprising instructions stored on the non-transitory storage medium what, when executed by the processor, configure the processor to:
configure at least one of a channel state information reference signal (CSI-RS) or a cell-specific reference signal (CRS) for DRS.

14. The article of manufacture of claim 12, further comprising instructions stored on the non-transitory storage medium what, when executed by the processor, configure the processor to determine a transmit power for the at least one of a channel state information reference signal (CSI-RS) or a cell-specific reference signal (CRS) of DRS.

15. The article of manufacture of claim 12, further comprising instructions stored on the non-transitory storage medium what, when executed by the processor, configure the processor to:
determine a total transmit power for a plurality of resource elements associated with the discovery reference signal (DRS).

16. The article of manufacture of claim 14, further comprising instructions stored on the non-transitory storage medium what, when executed by the processor, configure the processor to:
boost a power level of the discovery reference signal.

17. An article of manufacture comprising a non-transitory storage medium having instructions stored thereon that, when executed by a processor, configure the processor to:
configure at least one discovery reference signal (DRS) for path loss measurement;
determine a discovery reference signal power; and
transmit the discovery reference signal via a wireless communication link.

18. The article of manufacture of claim 17, further comprising instructions stored on the non-transitory storage medium what, when executed by the processor, configure the processor to:
estimate a reference signal received power (RSRP) parameter for the DRS;
determine the path loss parameter by subtracting the estimated RSRP parameter for the DRS from a reference signal transmitted power parameter received with the DRS;
determine a transmit power level for an uplink transmission using the path loss parameter.

19. The article of manufacture of claim 17, further comprising instructions stored on the non-transitory storage medium what, when executed by the processor, configure the processor to:
initiate an uplink transmission at the transmit power level.

20. The article of manufacture of claim 19, wherein the uplink transmission corresponds to at least one of a physical uplink shared channel (PUSCH) or a physical uplink control channel (PUCCH).

21. The article of manufacture of claim 19, wherein the uplink transmission corresponds to a sounding reference signal (SRS).

22. A controller comprising logic, at least partially including hardware logic, to:
configure at least one discovery reference signal (DRS) for path loss measurement;
determine a discovery reference signal power setting; and
transmit the discovery reference signal (DRS) via a wireless communication link.

23. The controller of claim 22, further comprising logic, at least partially including hardware logic, to:
configure at least one of a channel state information reference signal (CSI-RS) or a cell-specific reference signal (CRS) for DRS.

24. The controller of claim 23, further comprising logic, at least partially including hardware logic, to:
determine a transmit power for the at least one of a channel state information reference signal (CSI-RS) or a cell-specific reference signal (CRS) of DRS.

25. The controller of claim 22, further comprising logic, at least partially including hardware logic, to:
determine a total transmit power for a plurality of resource elements associated with the discovery reference signal (DRS).

26. The controller of claim 25, further comprising, logic, at least partially including hardware logic, to:
boost a power level of the discovery reference signal.

27. A controller comprising logic, at least partially including hardware logic, to:
configure at least one discovery reference signal (DRS) for path loss measurement;
determine a discovery reference signal power; and
transmit the discovery reference signal via a wireless communication link.

28. The controller of claim 27, further logic, at least partially including hardware logic, to:
estimate a reference signal received power (RSRP) parameter for the DRS;
determine the path loss parameter by subtracting the estimated RSRP parameter for the DRS from a reference signal transmitted power parameter received with the DRS; and
determine a transmit power level for an uplink transmission using the path loss parameter.

29. The controller of claim 27, further comprising logic, at least partially including hardware logic, to:
initiate an uplink transmission at the transmit power level.

30. The controller of claim 28, wherein the uplink transmission corresponds to at least one of a physical uplink shared channel (PUSCH) or a physical uplink control channel (PUCCH).

31. The controller of claim 28, wherein the uplink transmission corresponds to a sounding reference signal (SRS).
